(19) United States
(12) Patent Application Publication
(10) Pub. No.: US 2014/0048514 A1
(43) Pub. Date: Feb. 20, 2014

(54) CONTACT ASSEMBLY AND VACUUM SWITCH INCLUDING THE SAME

(71) Applicants: GANESH K. BALASUBRAMANIAN, Horseheads, NY (US); Stephen D. Mayo, Horseheads, NY (US)

(72) Inventors: GANESH K. BALASUBRAMANIAN, Horseheads, NY (US); Stephen D. Mayo, Horseheads, NY (US)

(21) Appl. No.: 13/589,687

(22) Filed: Aug. 20, 2012

(51) Int. Cl. H01H 33/664; H01H 11/06; H01H 11/04

(52) U.S. Cl. 218/124; 218/123; 29/876; 29/878

(57) ABSTRACT

A contact assembly for use in a vacuum switch includes an electrode stem and a contact coupled to an end portion of the electrode stem via a threaded fastener which threadingly engages a threaded portion of the electrode stem.

### BACKGROUND

1. Field

The disclosed concept pertains generally to circuit interrupters and, more particularly, to circuit interrupters employing a vacuum envelope such as, for example, a vacuum interrupter. The disclosed concept even more particularly pertains to contact assemblies used in vacuum interrupters.

2. Background Information

Circuit interrupters provide protection for electrical systems from electrical fault conditions such as, for example, current overloads, short circuits and abnormal voltage conditions. Typically, circuit interrupters include a spring powered operating mechanism which opens electrical contacts to interrupt the current through the conductors of an electrical system in response to abnormal conditions.

Circuit interrupters, such as, for example, power circuit breakers for systems operating above about 1,000 volts, typically utilize vacuum interrupters as the switching devices. For the higher voltages, or for a more compact arrangement, each vacuum interrupter is housed in a separate pod molded of an electrically insulative material, such as a polyglass. These molded pods, in turn, are bolted to a metal box containing the operating mechanism. The metal box is grounded to isolate the operating mechanism from the line voltage of the power circuit. Manual controls for the operating mechanism are accessible at the front face of the metal box. See, for example, U.S. Pat. No. 6,373,358.

Vacuum circuit interrupter apparatus include separable main contacts disposed within an insulating housing. Generally, one of the contacts is fixed relative to both the housing and to an external electrical conductor which is interconnected with the circuit to be controlled by the circuit interrupter while the other contact is movable. In the case of a vacuum circuit interrupter, the movable contact assembly usually comprises a stem of circular cross-section having the contact at one end enclosed within a vacuum chamber and a driving mechanism at the other end which is external to the vacuum chamber. An operating rod assembly comprising a push rod, which is fastened to the end of the stem opposite the movable contact, and a driving mechanism provide the motive force to move the movable contact into or out of engagement with the fixed contact.

Typically, each of the contacts is secured to the associated stem via a hub on the stem and a corresponding hole on the contact which mates with the hub. A braze washer, provided between the mating parts of each contact and associated stem, brazes the components together during a vacuum cycle in a vacuum furnace. In order to ensure a reliable braze joint, weight (typically 1 to 2 pounds) is applied to hold the joint between the contact and the stem together during the brazing operating. For a full furnace load, this can amount to 50 to 100 pounds of extra weight in the furnace.

There is room for improvement in electrical switching apparatus, such as vacuum interrupters.

There is also room for improvement in the methods employed for manufacturing vacuum interrupters.

### SUMMARY

These needs and others are met by embodiments of the disclosed concept which are directed to a contact assembly, a vacuum switch including a contact assembly, and a method of assembling a contact assembly.

As one aspect of the disclosed concept, a contact assembly for use in a vacuum switch is provided. The contact assembly comprises an electrode stem and a contact coupled to an end portion of the electrode stem via a threaded fastener which threadingly engages a threaded portion of the electrode stem.

The contact may be further coupled to the electrode stem via a braze material.

The threaded fastener may comprise a shoulder screw.

The threaded fastener may be formed from a material having a lower thermal expansion than a number of materials from which either the electrode stem or the contact is formed, such that during the brazing cycle the joint self-tightens.

The threaded fastener may be formed from one of a stainless steel material or a Nickel-Iron material.

As another aspect of the disclosed concept, a vacuum switch is provided. The vacuum switch comprises a vacuum envelope, a fixed contact assembly disposed partially within the vacuum envelope and a movable contact assembly disposed partially within the vacuum envelope and movable between a closed position in electrical contact with the fixed contact assembly and an open position spaced apart from the fixed contact assembly. At least one of the fixed contact assembly and the movable contact assembly comprise an electrode stem and a contact coupled to an end portion of the electrode stem via a threaded fastener which threadingly engages a threaded portion of the electrode stem.

The contact may be further coupled to the electrode stem via a braze material.

The threaded fastener may comprise a shoulder screw.

The threaded fastener may be formed from a material having a lower thermal expansion than a number of materials from which either the electrode stem or the fixed contact is formed, such that during the brazing cycle the joint self-tightens.

The threaded fastener may be formed from one of a stainless steel material or a Nickel-Iron material.

The vacuum switch may be a vacuum interrupter.

The other one of the fixed contact assembly and the movable contact assembly may comprise a second electrode stem and a second contact coupled to an end portion of the second electrode stem via a second threaded fastener which threadingly engages a threaded portion of the second electrode stem.

The second threaded fastener may comprise a second shoulder screw.

As yet another aspect of the invention, a method of assembling a contact assembly having an electrode stem and a contact for use in a vacuum switch is provided. The method comprises disposing the contact on a portion of the electrode stem and coupling the contact to the electrode stem via a threaded fastener.

Coupling the contact to the electrode stem via a threaded fastener may comprise coupling the contact to the electrode stem via a shoulder screw.

The method may further comprise providing a braze material between the contact and the portion of the electrode stem prior to coupling the contact to the electrode stem via the threaded fastener.

The method may further comprise brazing the contact to the electrode stem by subjecting the coupled contact and the electrode stem to a vacuum cycle in a vacuum furnace.

### BRIEF DESCRIPTION OF THE DRAWINGS

A full understanding of the disclosed concept can be gained from the following description of the preferred embodiments when read in conjunction with the accompanying drawings in which:

FIG. 1 is a cross-sectional view of a vacuum switch disposed in a closed position in accordance with an embodiment of the disclosed concept.

FIG. 2 is a cross-sectional view of the fixed contact assembly of the vacuum switch of FIG. 1.

FIG. 3 is a cross-sectional view of the movable contact assembly of the vacuum switch of FIG. 1

### DESCRIPTION OF THE PREFERRED EMBODIMENTS

As employed herein, the term “number” shall mean one or an integer greater than one (i.e., a plurality).

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

As employed herein, the term “vacuum envelope” means an envelope employing a partial vacuum therein.

As employed herein, the term “partial vacuum” means a space (e.g., within a vacuum envelope) partially exhausted (e.g., to the highest degree practicable; to a relatively high degree; to a degree suitable for use in a vacuum switching apparatus application) by a suitable mechanism (e.g., without limitation, an air pump; a vacuum furnace).

The disclosed concept is described in association with vacuum interrupters, although the disclosed concept is applicable to a wide range of vacuum switches.

The disclosed concept provides for an improved method of assembling contact assemblies for use in vacuum switches. The disclosed concept further provides for improved contact assemblies for use in vacuum switches.

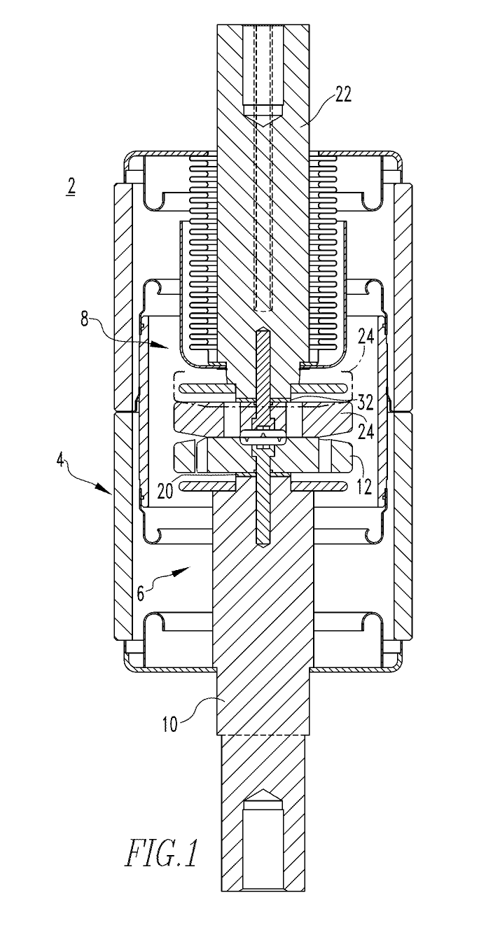

Referring to FIG. 1, a vacuum switch, such as a vacuum interrupter 2, is shown. The vacuum switch 2 includes a vacuum envelope 4, a fixed contact assembly 6 disposed partially within the vacuum envelope 4, and a movable contact assembly 8 disposed partially within the vacuum envelope 4 and movable between a closed position (as shown in FIG. 1) in electrical contact with the fixed contact assembly 6 and an open position (partially shown in phantom in FIG. 1) spaced apart from the fixed contact assembly 6.

Referring to FIG. 2, the fixed contact assembly 6 includes an electrode stem 10 and a fixed contact 12. The fixed contact 12 is at least initially coupled to, and pressed against, an end portion 14 of the electrode stem 10 via a threaded fastener, such as shoulder screw 16, which threadingly engages a threaded portion 18 of the electrode stem 10. Although shown as a shoulder screw 16 in the illustrated example embodiment, it is to be appreciated however that other suitable threaded fasteners may be employed without varying from the scope of the present invention. Before coupling the fixed contact 12 to the electrode stem 10, a braze material, such as braze washer 20 is provided between the electrode stem 10 and the fixed contact 12. After the fixed contact 12 is coupled to the electrode stem 10 via the shoulder screw 16, the assembly 6 is then subjected to a vacuum cycle in a vacuum furnace (not shown) that brazes the fixed contact 12 and the electrode stem 10 together. By utilizing the shoulder screw 16 to initially couple and press the fixed contact 12 to the electrode stem 10, the need for weights or other temporary fixing mechanisms aligning and pressing the fixed contact 12 against the electrode stem 10 together during the brazing process is eliminated.

In order to ensure that shoulder screw 16 tightly couples the fixed contact 12 to the electrode stem 10 during the vacuum cycle in the vacuum furnace, shoulder screw 16 is preferably formed from a material having a lower thermal expansion than the materials from which either of the fixed contact 12 or the electrode stem 10 are formed. Due to the different thermal expansions between the contact 12, electrode 10 and the screw 16, the braze joint is squeezed together during the brazing cycle.

In an example embodiment of the disclosed concept, the shoulder screw 16 is formed from stainless steel material (e.g., without limitation SST416) while the fixed contact 12 is formed from Copper-Chrome and the electrode stem 10 is formed from Oxygen Free High Conductivity (OFHC) Copper. In another example embodiment of the disclosed concept, the shoulder screw 16 is formed from Nickel-Iron material.

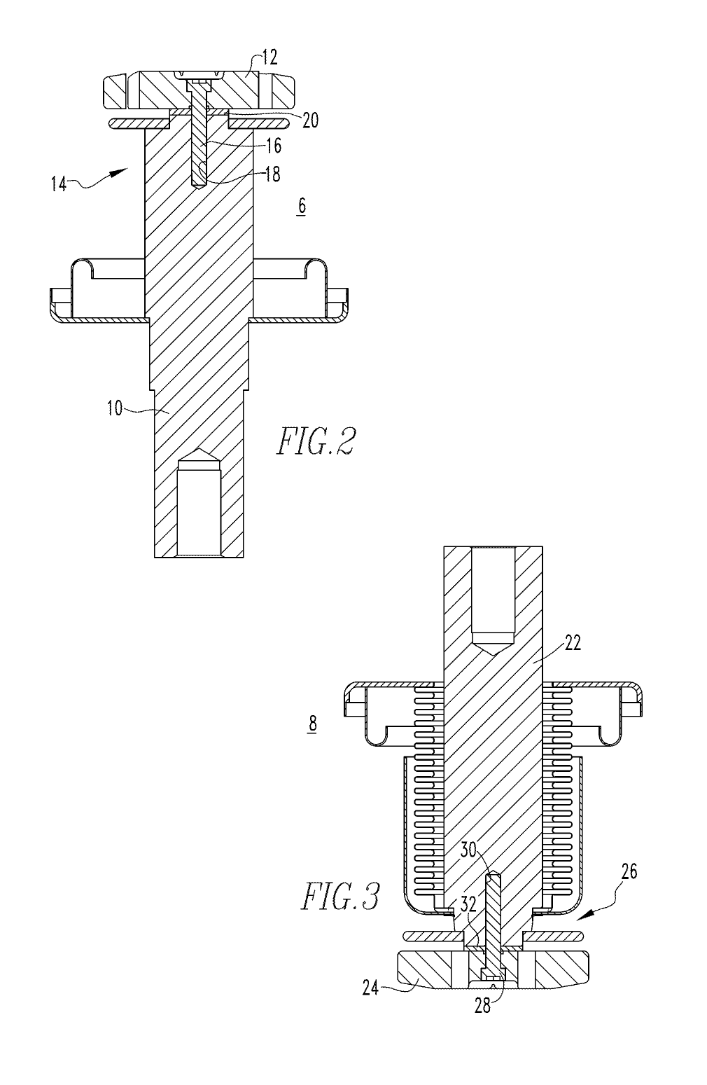

Referring to FIG. 3, the movable contact assembly 8 is generally assembled in a similar manner as the fixed contact assembly 6. Movable contact assembly 8 includes a movable electrode stem 22 and a movable contact 24. The movable contact 24 is at least initially coupled to, and pressed against, an end portion 26 of the movable electrode stem 22 via a threaded fastener, such as shoulder screw 28, which threadingly engages a threaded portion 30 of the movable electrode stem 22. Although shown as a shoulder screw 28 in the illustrated example embodiment, it is to be appreciated however that other suitable threaded fasteners may be employed without varying from the scope of the present invention. Before coupling the movable contact 24 to the movable electrode stem 22, a braze material, such as braze washer 32 is provided between the movable electrode stem 22 and the movable contact 24. After the movable contact 24 is coupled to the movable electrode stem 22 via the shoulder screw 28, the assembly 8 is then subjected to a vacuum cycle in a vacuum furnace (not shown) that brazes the movable contact 24 and the movable electrode stem 22 together. By utilizing the shoulder screw 28 to initially couple the movable contact 24 to the movable electrode stem 22, the need for weights or other temporary fixing mechanisms aligning and pressing the movable contact 24 against the movable electrode stem 22 during the brazing process is eliminated.

In order to ensure that shoulder screw 28 tightly couples the movable contact 24 to the movable electrode stem 22 during the vacuum cycle, shoulder screw 28 is preferably formed from a material having a lower thermal expansion than the materials from which either of the movable contact 24 or the movable electrode stem 22 are formed. In an example embodiment of the disclosed concept, the shoulder screw 28 is formed from stainless steel material (e.g., without limitation SST416) while the movable contact 24 is formed from Copper-Chrome and the movable electrode stem 22 is formed from Oxygen Free High Conductivity (OFHC) Copper. In another example embodiment of the disclosed concept, the shoulder screw 28 is formed from Nickel-Iron material.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A contact assembly for use in a vacuum switch, the contact assembly comprising:
an electrode stem; and
a contact coupled to an end portion of the electrode stem via a threaded fastener which threadingly engages a threaded portion of the electrode stem.

2. The contact assembly of claim 1 wherein the contact is further coupled to the electrode stem via a braze material.

3. The contact assembly of claim 1 wherein the threaded fastener comprises a shoulder screw.

4. The contact assembly of claim 1 wherein the threaded fastener is formed from a material having a lower thermal expansion than a number of materials from which either the electrode stem or the contact is formed.

5. The contact assembly of claim 1 wherein the threaded fastener is formed from one of a stainless steel material or a Nickel-Iron material.

6. A vacuum switch comprising:
a vacuum envelope;
a fixed contact assembly disposed partially within the vacuum envelope; and
a movable contact assembly disposed partially within the vacuum envelope and movable between a closed position in electrical contact with the fixed contact assembly and an open position spaced apart from the fixed contact assembly;
wherein at least one of the fixed contact assembly and the movable contact assembly comprises:
an electrode stem; and
a contact coupled to an end portion of the electrode stem via a threaded fastener which threadingly engages a threaded portion of the electrode stem.

7. The vacuum switch of claim 6 wherein the contact is further coupled to the electrode stem via a braze material.

8. The vacuum switch of claim 6 wherein the threaded fastener comprises a shoulder screw.

9. The vacuum switch of claim 6 wherein the threaded fastener is formed from a material having a lower thermal expansion than a number of materials from which either the electrode stem or the fixed contact is formed.

10. The vacuum switch of claim 6 wherein the threaded fastener is formed from one of a stainless steel material or a Nickel-Iron material.

11. The vacuum switch of claim 6 wherein the vacuum switch is a vacuum interrupter.

12. The vacuum switch of claim 6 wherein the other one of the fixed contact assembly and the movable contact assembly comprises:
a second electrode stem; and
a second contact coupled to an end portion of the second electrode stem via a second threaded fastener which threadingly engages a threaded portion of the second electrode stem.

13. The vacuum switch of claim 12 wherein the second threaded fastener comprises a second shoulder screw.

14. A method of assembling a contact assembly for use in a vacuum switch, the contact assembly having an electrode stem and a contact, the method comprising:
disposing the contact on a portion of the electrode stem; and
coupling the contact to the electrode stem via a threaded fastener.

15. The method of claim 14 wherein coupling the contact to the electrode stem via a threaded fastener comprises coupling the contact to the electrode stem via a shoulder screw.

16. The method of claim 14 further comprising providing a braze material between the contact and the portion of the electrode stem prior to coupling the contact to the electrode stem via the threaded fastener.

17. The method of claim 16 further comprising brazing the contact to the electrode stem by subjecting the coupled contact and the electrode stem to a vacuum cycle in a vacuum furnace.
